(19) United States
(12) Patent Application Publication
(10) Pub. No.: US 2005/0080184 A1
(43) Pub. Date: Apr. 14, 2005

(54) Molding composition and shaped plastics articles manufactured therefrom

(75) Inventors: Andreas Hajek, Brackenheim (DE); Thomas Heck, Aglasterhausen (DE)

Correspondence Address: EDWARD J. TIMMER, P. O. BOX 770, RICHLAND, MI, 49083, US

(73) Assignee: BLANCO GmbH + Co KG

(21) Appl. No.: 10/945,176

(22) Filed: Sep. 20, 2004

Related U.S. Application Data
(63) Continuation of application No. PCT/EP03/00912, filed on Jan. 30, 2003.

(30) Foreign Application Priority Data
Mar. 27, 2002 (DE) 102 14 436.2

(51) Int. Cl. C08K 3/34

(52) U.S. Cl. 524/492

(57) ABSTRACT

In order to provide curable molding compositions and shaped plastics articles prepared therefrom having an improved easy-clean property compared with the prior art, it is proposed that the curable molding composition for the production of shaped plastics articles contains a liquid monomeric methacrylate component and an amount of a particulate inorganic material ranging from 45 to 85 wt %, based on the molding composition, and that it further contains a hydrophobic monomeric component comprising at least one organosiloxane that is functionalized with an unsaturated group.

The invention relates to a curable molding composition for the production of shaped plastics articles, containing a liquid monomeric acrylate component and a proportion of particulate inorganic material ranging from 45 to 85 wt %, based on the molding composition. The invention also relates to shaped plastics articles produced from the aforementioned molding composition. In addition, the invention relates to the use of organosiloxanes functionalized with unsaturated groups as the monomeric component of said curable molding composition serving as material for the production of shaped articles of sanitary facilities, particularly kitchen sink units and kitchen worktops.

Diverse molding compositions of the aforementioned type are disclosed in the literature, for example, in German Patent DE 24 49 656 and also European Patent EP 0 361 101 or WO 95/23825. They are used to a large extent in the production of shaped plastics articles, particularly in the form of kitchen sink units, worktops, wash basins, bathtubs, shower basins etc. and are characterized by a number of excellent performance characteristics.

In the case of shaped plastics articles to be used in the kitchen, in particular, their easy-clean property is of great significance.

Prior shaped plastics articles produced from conventional curable molding compositions have a satisfactory easy-clean property.

However in the kitchen, in particular, the shaped plastics articles, for example kitchen sink units, frequently get persistent stains comprising proteins, starch, and greases, which have to be removed with aggressive cleaning agents, such as scouring agents. In addition to their environmental inacceptability, aggressive cleaning agents cause changes in the surface properties of the shaped plastics articles and lead to aging phenomena manifested, for example, in a reduced easy-clean property of the shaped article. In addition, thermal and mechanical stresses caused, for example, when a hot cooking pot is placed on a kitchen sink unit, produce an aging effect which impairs the easy-clean property.

Starting from this situation, there is a need for the provision of curable molding compositions and shaped plastics articles produced therefrom which show an improved easy-clean property.

This object is achieved in the present invention in that the aforementioned molding composition additionally contains a hydrophobic monomeric component comprising at least one organosiloxane functionalized with an unsaturated group.

DE 35 35 283 A1 describes varnishes which are based on unsaturated polyester and vinyl resins and which, in order to impart an antigraffito effect thereto, comprise polysiloxanes functionalized with a -Z-R-Q group, in which Z stands for an alkyl group, R for a polyester group and Q for, inter alia, an unsaturated group. Shaped plastics articles produced from molding compositions and retaining their easy-clean properties when subjected to constant abrasive, thermal, and mechanical stresses are not described in this publication.

It has been found that the addition of organosiloxanes that are functionalized with unsaturated groups to the molding composition of the invention gives shaped plastics articles having a distinctly improved easy-clean property. This results from the fact that the organosiloxanes functionalized with unsaturated groups reduce the surface energy of the aforementioned shaped plastics articles based on a liquid monomeric acrylate component.

The lower the surface energy of a surface, the more difficult it becomes to make it wet. In this case interactions taking place between the relevant phases at the phase boundary play an important part. The surface energy (surface tension) can be subdivided into a polar portion and a dispersive portion. A polar liquid, for example, interacts substantially with the polar portion of the surface energy of a solid surface, ie with its directional forces, whilst a non-polar liquid, for example, interacts substantially with the dispersive portion, ie with the non-directional forces. A correlation between surface energy and dirt-collecting properties is given by the fact that simultaneously lowering the dispersive and polar portions of the surface energy produces generally poor wettability of the shaped plastics articles since the interaction of non-polar and polar dirt-carrying agents with the shaped plastics article is reduced (hydrophobic and oleophobic adjustment of the surface of the sink).

Surprisingly, we have found that this improved cleaning property is retained even after intense abrasive treatment of the shaped article. Presumably, an organosiloxane functionalized with an unsaturated group is substantially homogeneously introduced into the polymer chains of the polymer matrix throughout the shaped article.

Another advantageous effect of the molding compositions of the invention resides in the fact that when use is made of organosiloxanes functionalized with acrylate or methacrylate groups and based on organosiloxanyl derivatives of alkanediol monovinyl ethers there are produced shaped plastics articles having an improved UV resistance, ie a reduced tendency to aging. Unlike shaped plastics articles produced from conventional molding compositions, whose surface energy, and thus their wettability, increases under the action of UV radiation, the surface energy of a shaped plastics article produced from a molding composition of the invention using organosiloxanes based on organosiloxanyl derivatives of alkanediol monovinyl ethers that are functionalized with acrylate and/or methacrylate groups remains almost constant or may even diminish whether subjected to the action of UV light or not.

Organosiloxanes that are functionalized with an unsaturated group preferably comprise one or more ethenyl, ethene-1,1-diyl or ethene-1,2-diyl groups.

Advantageously, suitable organosiloxanes functionalized with an ethenyl or ethene-1,1-diyl group are organosiloxanes that are functionalized with acrylate or methacrylate groups, since they are highly compatible with the liquid monomeric acrylate component of the curable molding composition and are substantially easily introduced into the polymer chains during curing of the shaped plastics article. By the term acrylate component we mean all esters of propenoic acid, such as methyl or ethyl esters of propenoic acid, and derivatives thereof, such as methyl or ethyl acrylate. By acrylate-functionalized organosiloxanes we mean those organosiloxanes which comprise an acrylate group.

Conveniently, the organosiloxanes that are functionalized with an unsaturated group are based on organosiloxanyl derivatives of alkanediol monovinyl ethers, particularly butane-1,4-diol monovinyl ether, these being very readily and cheaply obtained by transition metal-catalyzed hydrosilylation of organosiloxanyl derivatives on alkanediol monovinyl ethers, as described in European Patent EP 0 819 719. The resultant hydroxyalkyl-functionalized organosiloxane derivatives can be esterified with, say, unsaturated carboxylic acids to form double bond-functionalized organosiloxanes.

The content of hydrophobic monomeric component is usually in the region of from ca 0.1 to ca 15 wt %, the aforementioned advantages being only weakly pronounced below the lower limit, whilst above the upper limit no substantial improvement on the aforementioned advantageous effects can be obtained.

The preferred content of hydrophobic monomeric component is in the range of from 1 to 12 wt %. The best results have been obtained in the range of from 2 to 10 wt %, and the range most preferred for the content of hydrophobic monomeric component, particularly when considering cost factors, is from 3 to 8 wt %.

Advantageously, the molding composition of the invention further comprises at least one particulate hydrophobic and/or oleophobic material, for example, polytetrafluoroethylene, fluorocarbon elastomers based on poly(vinylidene fluoride-co-hexafluoropropylene)s, polypropylene or polypropylene comonomers, which improve, for example, the hot-pot resistance, the scratch proofness, the easy-clean property, and also the luster of the shaped plastics article, or silicone elastomers or hydrophobed silicic acid, which improve the scratch proofness, the impact strength, and the abrasion resistance of the shaped plastics article.

The content of particulate hydrophobic and/or oleophobic material is in the range of from ca 0.5 to ca 15 wt %, preferably from 1 to 10 wt %, and more preferably from 2 to 7 wt %.

The particle size of the particulate hydrophobic and/or oleophobic material is not in fact critical, but an upper limit to the particle size or agglomerated particle size of 500 μm is recommended, in order that the addition of this material to the face side of the shaped plastics article to be manufactured does not spoil the optical appearance thereof. When average particle sizes of ≦50 μm are used, even optically high-grade materials suffer no kind of impairment.

As mentioned above, the invention relates to shaped plastics articles which have been produced using the aforementioned curable molding composition and in which preferably at least one face-side surface layer of the shaped article is formed by the molding composition of the invention.

If only the face-side surface layer is formed by the curable molding composition of the invention and the rest of the shaped article is composed of some other molding composition, it is recommended that the surface layer has a thickness of 1 mm or more. This layer thickness of 1 mm is quite sufficient to provide the shaped plastics article with all of the advantageous effects described above.

Preferably, the hydrophobic and/or oleophobic material will be substantially homogeneously distributed in the regions formed by the molding composition.

As indicated above, the curable molding composition of the invention is particularly suitable for the production of kitchen sink units and kitchen worktops since in just such circumstances persistent stains are caused by fats, proteins, or starch.

Finally, the invention also relates to the use of organosiloxanes that are functionalized with unsaturated groups as a component of curable molding compositions employed for the production of shaped articles in sanitary facilities, particularly kitchen sink units and kitchen worktops, such functionalized organosiloxanes being preferably used in molding compositions of the type discussed above.

These and other advantages of the present invention are described below in greater detail with reference to the examples.

There follows a preliminary discussion of the various test methods for the assessment of the surface quality of the shaped plastics articles produced in accordance with the invention:

1. Surface Energy

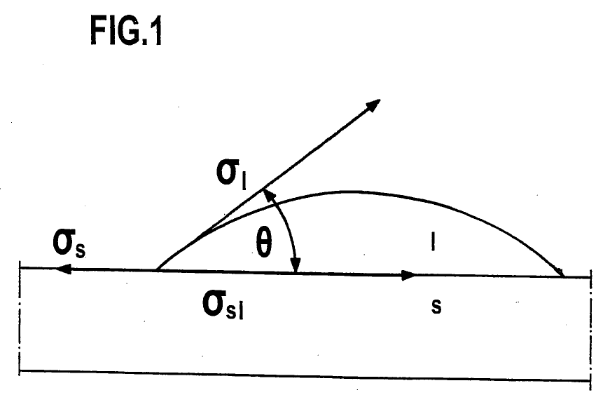

The surface energy (surface tension) of solid bodies is determined by means of drop contour analysis using a contact angle meter G10/DAS10 marketed by Krüss. For this purpose, drops of a polar solution (water) and a non-polar solution (diiodomethane), whose surface tensions are known, are placed on the clean surface of a test piece. The drops are measured to determine the contact angle θ (FIG. 1), this being the angle at which the drop contour line meets the substrate. The contact angle measurements of at least two test liquids will make it possible to deduce the surface energy of solid bodies.

The correlation between the phases to be observed (solid (s), liquid (l)), their respective surface tensions σ_{f} and σₗ, the surface tension at the solid-liquid interface (σₛₗ), and the observable contact angle θ of the drop, is expressed by the following equation formulated by Young:
σₛ=σₛₗ+σₗ·cos θ. (1)

The interfacial tension of each phase can be subdivided into a polar portion (p) and a dispersive portion (d). The polar portion is characterized by dipole-dipole interactions, hydrogen bridge bonds, or Lewis acid/Lewis base interactions. The dispersive portion includes van der Waals' interactions. The contact angle is defined as the progressive angle assumed between the test liquid (l) having known polar and dispersive portions σₗ^{p}, and σₗ^{d} and the solid surface (s). To this end, a drop is placed on the solid surface and continuously enlarged by introducing measuring fluid without removing the hollow needle used to introduce the liquid into the drop. First of all the contact angle increases with the drop size whilst the area of the wetted surface remains unchanged. At a certain size the drop begins to spread over the solid surface at a constant contact angle. The contact angle of a drop which remains constant while liquid is added to the drop is the progressive angle. The addition of liquid is stopped prior to measurement, in order to eliminate the fluid pressure in the hollow needle. The contact angle is then determined with the aforementioned optical measuring means.

According to Owens, Wendt, Rabel, and Kaeble, the equations σₗ=σₗ^{d}+σₗ^{p} and σₛ=σₛ^{d}+σₛ^{p} give the following relationship:
σₛₗ=σₛ+σₗ−2(\sqrt{σₛ^{d}·σₗ^{d}}+\sqrt{σₛ^{p}·σₗ^{p}}). (2)

Using relationship (2) and equation (1) it is possible to describe cos θ by the following surface energetic state equation:
cos θ=f(σₛ, σₛ^{d}, σₗ, σₗ^{d}). (3)

Substitution of relationship (2) in equation (1) followed by conversion thereof gives a rectilinear equation, from the slope and axis intercept of which the polar and dispersive portions of the surface energy of a solid surface are determined by measuring the progressive angle of, say, water and diiodomethane, whose values for σₗ-, σₗ^{d}- and σₗ^{p} are recorded in the literature.

2. UV Irradiation Test

The UV irradiation test is carried out according to DIN ISO 4892-2A using the testing apparatus XT 1200 LM, marketed by Atlas. The individual testing conditions used were as follows:

| Light source: | Xenon arc |
|---|---|
| Filter system: | 3 Suprax |
| Intensity of irradiation: | 60 W/m² at 300 to 400 nm |
| Testing cycle: | 102 min irradiation und 18 min irradiation |
| | accompanied by water spray |
| Total testing period: | 777 h |
| Black standard temperature: | 65 ± 3° C. |
| Room temperature during | 38 ± 3° C. |
| tests: | |
| Relative humidity: | 65 ± 5% |

The UV radiation applied to the test piece during the test corresponds to an annual dose in Central Europe of 1,538 MJ/m² (behind window glass with constant wetting of the surface with water).

3. Cleaning Test

In conjunction with the determination of a rating of the easy-clean property or, in other words, the staining proneness of the shaped plastics article formed, a synthetic model dirt batch is applied, after which the dirt is cleaned off under defined conditions.

The model dirt batch used has the following composition:

| | |
|---|---|
| 7% w/w | “Spezialschwarz 4”, carbon black (Degussa AG) |
| 40% w/w | Process oil 310 (ESSO AG) |
| 17% w/w | Arlypon DV, C₈-fatty acid glycerol ester |
| | (Grünau Illertissen GmbH) |
| 36% w/w | Gasoline, bp. 65/100° C. (Fluka: 12270) |

4. Abrasive Pretreatment

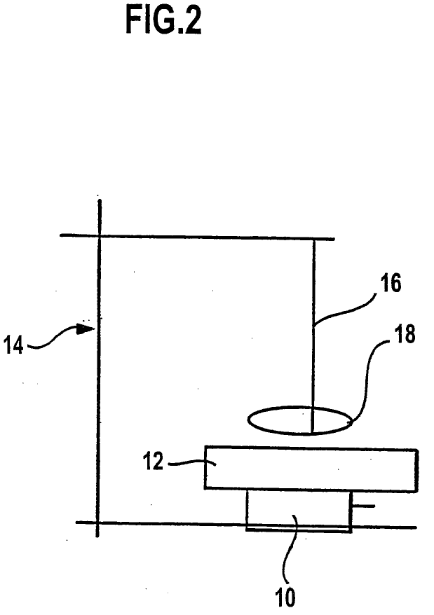

6 g of aluminum oxide having a particle-size range of from 63 μm to 200 μm (active, neutral aluminum oxide 90 sold by Merck, Germany) are distributed over the test piece. Using a round moistened sponge this amount of aluminum oxide is applied to the surface of the test piece by carrying out uniform rotatory motion at 60 rpm under a weight of 4 kg. The procedure is stopped after the 100th or 250th revolution respectively. Cleaning off of the model dirt batch from the surface to be tested is effected with cleaning apparatus as illustrated diagrammatically in FIG. 2. The experimental arrangement is described briefly below:

A balance 12 is placed on an elevating platform 10, to which the test piece (not shown) can be fixed.

A variable-speed agitator 14 is positioned next to the arrangement of elevating platform 10 and balance 12 such that its motor shaft 16 is positioned vertically above the center of balance 12. Under test conditions, a round sponge 18 is fixed to the bottom free end of the motor shaft 16 and is non-rotatably attached to said shaft 16.

During execution of the clean-off test, the balance is raised by means of the elevating platform until the sponge is shown to be weighted by 4 kg.

Detailed Test Procedure:

0.3 g of the model dirt batch comprising the aforementioned ingredients is placed on a watch glass and is uniformly spread over the test area (ca 10 cm²) with the aid of a dirt-saturated flat brush using horizontally and vertically overlapping brushstrokes. It is left for a period of 60 min. The surface is then washed with warm water until no more carbon black is removed. It is then rinsed with demineralized water and dried in air. The residual dirt is taken to be the color difference. The reference is always the unprocessed test piece. It should be noted that the reference value should be measured for each individual test piece, since the color values of the test pieces may differ from each other slightly.

Cleaning Procedure

The stained test pieces are cleaned with 10 circular movements (at a speed of 60 rpm) under a weight of 4 kg. For this purpose there are used 6 g of the cleaner Blanco Clean (mineral cleaner content: 21.5%, sold by BLANCO, Germany). Cleaning is carried out using an unused, fine-pored, and moistened sponge having a diameter of ca 8 cm. Following cleaning, the test area is washed well, rinsed with demineralized water, and air-dried. The residual stain is taken to be the color difference measured against the unprocessed test piece and is stated as the ΔE value:

$$Δ E = \sqrt{{{( {L}_{ref} - {L}_{sample} )}^{2} + {a}_{ref} - {a}_{sample} )}^{2} + {( {b}_{ref} - {b}_{sample} )}^{2}}$$

The residual stain [% RS] is calculated from the AE values before and after cleaning of the surfaces concerned as follows:

$$RS = \frac{Δ {E}_{cleaned}}{Δ {E}_{stained}} \cdot 100$$

The invention is illustrated below in greater detail with reference to examples and comparative examples:

### COMPARATIVE EXAMPLE 1

2.0 kg of polymethyl methacrylate (PMMA) of standard type having a molecular weight \overline{M}_{w} ranging from 50,000 to 250,000 are dissolved in 8.0 kg of methyl methacrylate (MMA), and to this solution there are added a release agent (35 g of stearic acid, sold by Merck, Germany) and a crosslinking agent (200 g of trimethylolpropane trimethacrylate, sold by Agomer, Germany). There is obtained a relatively viscous syrup.

In this syrup there are then dispersed 28 kg of a quartz sand (silanized), in which each grain has a core substantially of quartz and a surface comprising substantially α-cristobalite (EP 0,716,097 B1. ACQ, sold by Quarzwerke, Germany) and is present in a particle-size range of from 100 μm to 500 μm. Then a white pigment dispersion, comprising 1.4 kg of the aforementioned syrup, 1.3 kg of another crosslinking agent (bisphenol-A-ethoxylate dimethacrylate, sold by Akzo Nobel Chemical, Germany), and 2.3 kg of a white pigment (titanium(IV) oxide, sold by Kemira, Finland) are added.

The addition of peroxides (60 g of Peroxan BCC, 120 g of Peroxan LP and 10 g of Peroxan TB, all sold by Pergan, Germany) is then carried out followed by thermal curing of the molding composition in suitable (kitchen sink unit) molds.

Test pieces of the sink units are stained with and without abrasive pretreatment (see above) and then cleaned under defined conditions (see above), and the residual stain remaining on the surface is determined by photoelectric photometry.

A test piece of the kitchen sink unit is measured prior to and after UV irradiation to determine the overall surface energy and the polar and dispersive portions thereof. Furthermore test pieces are stained prior to and after UV irradiation and with and without abrasive pretreatment (see above) using a synthetic model dirt batch and then cleaned under defined conditions (see above), and the residual stain on the surface is determined by photoelectric photometry.

a) Test Piece Prior to UV Irradiation

| | |
|---|---|
| Surface energy: | 43.28 mN/m |
| dispersive portion: | 40.44 mN/m |
| polar portion: | 2.84 mN/m |
| Residual stain with no abrasive pretreatment: | 12% |
| Residual stain with an abrasive pretreatment | 11% |
| of 100 cycles: | |
| Residual stain with an abrasive pretreatment | 11% |
| of 250 cycles: | |

b) Test Piece After UV Irradiation

| | |
|---|---|
| Surface energy: | 45.99 mN/m |
| dispersive portion: | 25.33 mN/m |
| polar portion: | 20.66 mN/m |
| Residual stain with no abrasive pretreatment: | 16% |
| Residual stain with an abrasive pretreatment | 8% |
| of 100 cycles: | |
| Residual stain with an abrasive pretreatment | 7% |
| of 250 cycles: | |

### COMPARATIVE EXAMPLE 2

In the mixture of Comparative Example 1 there is dispersed 0.60 kg of a PTFE micropowder (SST-2; sold by Shamrock, d=ca 12.5 μm).

Peroxides are then added and the molding composition is thermally cured in suitable (kitchen sink unit) molds as described in Comparative Example 1.

A test piece of the kitchen sink unit is measured prior to and after UV irradiation to determine the surface energy and the dispersive and polar portions thereof. Furthermore, test pieces are stained prior to and following UV irradiation and with and without abrasive pretreatment with a synthetic model dirt batch and then cleaned under defined conditions, and the residual stain left on the surface is determined by photoelectric photometry.

a) Test Piece Prior to UV Irradiation

| | |
|---|---|
| Surface energy: | 43.34 mN/m |
| dispersive portion: | 38.87 mN/m |
| polar portion: | 4.47 mN/m |
| Residual stain with no abrasive pretreatment: | 5% |
| Residual stain with an abrasive pretreatment | 7% |
| of 100 cycles: | |
| Residual stain with an abrasive pretreatment | 6% |
| of 250 cycles: | |

b) Test Piece Following UV Irradiation

| | |
|---|---|
| Surface energy: | 43.97 mN/m |
| dispersive portion: | 30.42 mN/m |
| polar portion: | 13.55 mN/m |
| Residual stain with no abrasive pretreatment: | 13% |
| Residual stain with an abrasive pretreatment | 6% |
| of 100 cycles: | |
| Residual stain with an abrasive pretreatment | 5% |
| of 250 cycles: | |

### EXAMPLE 1

To the mixture of Comparative Example 1 there are added 0.70 kg of an acrylate-functionalized oligosiloxane (Tegomer V-Si 7255; sold by Goldschmidt AG, Germany). Peroxides are then added and the molding composition is thermally cured in suitable (kitchen sink unit) molds as described in Comparative Example 1.

A test piece of the kitchen sink unit is measured prior to and following UV irradiation to determine its surface energy and the dispersive and polar portions thereof. Furthermore, test pieces are stained prior to and following UV irradiation and with and without abrasive pretreatment with a synthetic model dirt batch and then cleaned under defined conditions, and the residual stain left on the surface is determined by photoelectric photometry.

a) Test Piece Prior to UV Irradiation

| | |
|---|---|
| Surface energy: | 31.75 mN/m |
| dispersive portion: | 28.35 mN/m |
| polar portion: | 3.40 mN/m |
| Residual stain with no abrasive pretreatment: | 4% |
| Residual stain with an abrasive pretreatment | 5% |
| of 100 cycles: | |
| Residual stain with an abrasive pretreatment | 4% |
| of 250 cycles: | |

b) Test Piece Following UV Irradiation

| | |
|---|---|
| Surface energy: | 28.22 mN/m |
| dispersive portion: | 22.94 mN/m |
| polar portion: | 5.28 mN/m |
| Residual stain with no abrasive pretreatment: | 12% |
| Residual stain with an abrasive pretreatment | 6% |
| of 100 cycles: | |
| Residual stain with an abrasive pretreatment | 6% |
| of 250 cycles: | |

### EXAMPLE 2

In the mixture of Example 1 there are dispersed 0.73 kg of an acrylate-functionalized oligosiloxane (Tegomer V-Si 7255; sold by Goldschmidt AG, Germany) and 0.62 kg of a particulate PTFE micropowder (SST-2; sold by Shamrock, d=ca 12.5 μm). Peroxides are then added and the molding composition is thermally cured in suitable (kitchen sink unit) molds as described in Comparative Example 1.

A test piece of the kitchen sink unit is measured to determine its surface energy and the dispersive and polar portions thereof. Furthermore, test pieces are stained prior to and following irradiation and with and without abrasive pretreatment with a synthetic model dirt batch and then cleaned under defined conditions, and the residual stain left on the surface is determined by photoelectric photometry.

a) Test Piece Prior to UV Irradiation

| | |
|---|---|
| Surface energy: | 33.19 mN/m |
| dispersive portion: | 32.88 mN/m |
| polar portion: | 0.31 mN/m |
| Residual stain with no abrasive pretreatment: | 7% |
| Residual stain with an abrasive pretreatment | 4% |
| of 100 cycles: | |
| Residual stain with an abrasive pretreatment | 4% |
| of 250 cycles: | |

b) Test Piece Following UV Irradiation

| | |
|---|---|
| Surface energy: | 32.71 mN/m |
| dispersive portion: | 27.79 mN/m |
| polar portion: | 4.92 mN/m |
| Residual stain with no abrasive pretreatment: | 13% |
| Residual stain with an abrasive pretreatment | 5% |
| of 100 cycles: | |
| Residual stain with an abrasive pretreatment | 5% |
| of 250 cycles: | |

### EXAMPLE 3

To the mixture of Comparative Example 1 there are added 0.73 kg of an acrylate-functionalized oligosiloxane (Tegomer Vsi 7255; sold by Goldschmidt AG, Germany) and 0.33 kg of a hydrophobed microdispersed silicic acid brand (dry matter 720; d=ca 20 nm; sold by Cabot) are dispersed therein. Peroxides are then added and the molding composition is thermally cured in suitable (kitchen sink unit) molds as described in Comparative Example 1.

A test piece of the kitchen sink unit is measured to determine its surface energy and the dispersive and polar portions thereof. Furthermore, test pieces of the kitchen sink unit are stained prior to and following UV irradiation and with and without abrasive pretreatment with a synthetic model dirt batch and are then cleaned under defined conditions, and the residual stain left on the surface is determined by photoelectric photometry.

a) Test Piece Prior to UV Irradiation

| | |
|---|---|
| Surface energy: | 37.95 mN/m |
| dispersive portion: | 37.20 mN/m |
| polar portion: | 0.75 mN/m |
| Residual stain with no abrasive pretreatment: | 6% |
| Residual stain with an abrasive pretreatment | 3% |
| of 100 cycles: | |
| Residual stain with an abrasive pretreatment | 4% |
| of 250 cycles: | |

b) Test Piece Following UV Irradiation

| | |
|---|---|
| Surface energy: | 34.31 mN/m |
| dispersive portion: | 24.60 mN/m |
| polar portion: | 9.72 mN/m |
| Residual stain with no abrasive pretreatment: | 13% |
| Residual stain with an abrasive pretreatment | not determined |
| of 100 cycles: | |
| Residual stain with an abrasive pretreatment | not determined |
| of 250 cycles: | |

TABLE 1

| | Comparative | Comparative | | | |
|---|---|---|---|---|---|
| | Example 1 | Example 2 | Example 1 | Example 2 | Example 3 |
| Functionalized | — | — | Acrylate- | Acrylate- | Acrylate- |
| organosiloxane | | | functionalized | functionalized | functionalized |
| | | | organosiloxane | organosiloxane | organosiloxane |
| Content of matrix material | — | — | 5.5 | 5.5 | 5.5 |
| [% w/w] | | | | | |
| Hydrophobic and/or | — | PTFE | — | PTFE | Hydrophobized |
| oleophobic material | | | | | silicic acid |
| Content of matrix material | — | 4.7 | — | 4.7 | 2.5 |
| [% w/w] | | | | | |

Prior to UV-irradiation

| | | | | | |
|---|---|---|---|---|---|
| Surface energy | 43.28 | 43.34 | 31.75 | 33.19 | 37.95 |
| [mN/m] | | | | | |
| Dispersive portion [mN/m] | 40.44 | 38.87 | 28.35 | 32.88 | 37.20 |
| Polar portion [mN/m] | 2.84 | 4.47 | 3.40 | 0.31 | 0.75 |
| Treatment cycles [rev.] | 0 | 0 | 0 | 0 | 0 |
| Residual stain [%] | 12 | 5 | 4 | 7 | 6 |
| Treatment cycles [rev.] | 100 | 100 | 100 | 100 | 100 |
| Residual stain [%] | 11 | 7 | 5 | 4 | 3 |
| Treatment cycles [rev.] | 250 | 250 | 250 | 250 | 250 |
| Residual stain [%] | 11 | 6 | 4 | 4 | 4 |

TABLE 2

| | Comparative | Comparative | | | |
|---|---|---|---|---|---|
| | Example 1 | Example 2 | Example 1 | Example 2 | Example 3 |
| Functionalized | — | — | Acrylate- | Acrylate- | Acrylate- |
| organosiloxane | | | functionalized | functionalized | functionalized |
| | | | organosiloxane | organosiloxane | organosiloxane |
| Content of matrix material | — | — | 5.5 | 5.5 | 5.5 |
| [% w/w] | | | | | |
| Hydrophobic and/or oleophobic | — | PTFE | — | PTFE | hydrophobized |
| material | | | | | silicic acid |
| Content of matrix material | — | 4.7 | — | 4.7 | 2.5 |
| [% w/w] | | | | | |

After UV-irradiation (radiation dose: 1,538 MJ/m²)

| | | | | | |
|---|---|---|---|---|---|
| Surface energy[mN/m] | 45.99 | 43.97 | 28.22 | 32.71 | 34.31 |
| dispersive portion [mN/m] | 25.33 | 30.42 | 22.94 | 27.79 | 24.60 |
| Polar portion [mN/m] | 20.66 | 13.55 | 5.28 | 4.92 | 9.72 |
| Treatment cycles [rev.] | 0 | 0 | 0 | 0 | 0 |
| Residual stain [%] | 16 | 13 | 12 | 13 | 13 |
| Treatment cycles [rev.] | 100 | 100 | 100 | 100 | 100 |
| Residual stain [%] | 8 | 6 | 6 | 5 | not determined |
| Treatment cycles [rev.] | 250 | 250 | 250 | 250 | 250 |
| Residual stain [%] | 7 | 5 | 6 | 5 | not determined |

The results obtained from the analysis of the surface energy and the cleaning characteristics of a test piece of Comparative Examples 1 and 2 and one of Examples 1 to 3 prior to and following UV irradiation are summarized in Table 1 and Table 2 respectively.

A test piece in accordance with Comparative Example 1 has a surface energy of 43.28 mN/m prior to UV irradiation, its dispersive portion having a value of 40.44 mN/m and its polar portion a value of 2.84 mN/m. The test piece not subjected to abrasive pretreatment has, after the cleaning test, a residual stain of 12%, and test pieces subjected to an abrasive pretreatment of 100 and 250 treatment cycles respectively have residual stains of 11% in each case. Following UV irradiation using an irradiation dosage of 1,538 MJ/m², a test piece according to Comparative Example 1 has, compared with the unexposed test piece, an increased surface energy of 45.99 mN/m, the dispersive portion thereof being 25.33 mN/m and the polar portion thereof 20.66 mN/m. The cleaning property of such a test piece is distinctly worse than an unexposed test piece and has a residual stain after the cleaning test of 16%. The easy-clean property of the abrasively pre-treated and irradiated test pieces shows, compared with the abrasively pre-treated, unexposed test pieces a very distinct improvement of 8% (100 treatment cycles) and 7% (250 treatment cycles) respectively.

Compared with a test piece according to Comparative Example 1, a test piece according to Comparative Example 2 has an additional content of 4.7 wt % of PTFE micropowder, which has a relatively small influence on the surface energy of the test piece but causes a drop in the dispersive portion of the surface energy and a corresponding increase in its polar portion. Compared with a test piece according to Comparative Example 1, a test piece according to Comparative Example 2 has a distinctly improved easy-clean property with or without abrasive pretreatment. UV irradiation at an irradiation dosage of 1,538 MJ/m² causes only a slight increase in the surface energy but distinctly changes the ratio of its dispersive and polar portions in favor of the polar portion. A test piece according to Comparative Example 2 has, following UV irradiation in the cleaning test, a residual stain which is much more intense than on an unexposed test piece and which is distinctly less intense on abrasively pretreated test pieces.

Compared with a test piece according Comparative Example 1, a test piece according to Example 1 additionally contains a proportion of 5.5 wt % of acrylate-functionalized organosiloxane and has, compared with a test piece according to Comparative Example 1 or 2, a distinctly reduced surface energy, particularly the dispersive portion thereof, accompanied by a distinctly improved easy-clean property of the test piece before and after abrasive pre-treatment. UV irradiation of such a test piece with an irradiation dosage of 1,538 MJ/m² causes lowering of the surface energy and a change in the ratio of the dispersive portion to the polar portion in favor of the polar portion, and the test piece, when subjected to the cleaning test, shows a much more intense residual stain, which is distinctly less intense when abrasive pre-treatment is carried out.

Compared with a test piece according to Comparative Example 1, a test piece according to Example 2 additionally contains 5.5 wt % of an acrylate-functionalized organosiloxane and 4.7 wt % of a PTFE micropowder and has, compared with a test piece according to Comparative Example 1 or 2, a distinctly reduced surface energy as regards both the dispersive portion and the polar portion thereof and also a distinctly improved easy-clean property before and after abrasive pretreatment. UV irradiation of such a test piece with an irradiation dosage of 1,538 MJ/m² causes slight lowering of the surface energy but a distinct change in the ratio of the dispersive portion thereof to the polar portion thereof in favor of the polar portion. The UV irradiation causes a reduction in the easy-clean property of the test piece, which is less pronounced, however, on abrasively pretreated test pieces.

Compared with a test piece according to Comparative Example 1, a test piece according to Example 3 contains 5.5 wt % of an acrylate-functionalized organosiloxane and 2.5 wt % of a hydrophobed silicic acid, and has a distinctly lower surface energy than a test piece according to Comparative Example 1 or 2 in respect of both the dispersive portion and the polar portion thereof and also has a distinctly improved easy-clean property before and after abrasive pretreatment. UV irradiation of such a test piece at an irradiation dosage of 1,538 MJ/m² causes lowering of the overall surface energy and a change in the ratio of the dispersive and polar portions in favor of the polar portion and also shows an impaired easy-clean property of a test piece.

1. A curable molding composition for the production of shaped plastics articles comprising a liquid monomeric acrylate component and an amount of a particulate inorganic material ranging from 45 to 85 wt %, based on the molding composition, characterized in that said molding composition also contains a hydrophobic monomeric component which comprises at least one organosiloxane that is functionalized with an unsaturated group.

2. A molding composition as defined in claim 1, characterized in that said organosiloxane that is functionalized with an unsaturated group is an organosiloxane functionalized with an ethenyl, ethene-1,1-diyl and/or ethene-1,2-diyl group.

3. A molding composition as defined in claim 2, characterized in that said organosiloxane that is functionalized with an ethenyl group is an acrylate-functionalized organosiloxane.

4. A molding composition as defined in claim 2, characterized in that said organosiloxane that is functionalized with an ethene-1,1-diyl group is a methacrylate-functionalized organosiloxane.

5. A molding composition as defined in claim 1, characterized in that said organosiloxane that is functionalized with an unsaturated group is based on an organosiloxanyl derivative of an alkanediol monovinyl ether.

6. A molding composition as defined in claim 1, characterized in that said organosiloxane that is functionalized with an unsaturated group is based on an organosiloxanyl derivative of butane-1,4-diol monovinyl ether.

7. A molding composition as defined in claim 1, characterized in that the content of hydrophobic monomeric component is from ca 0.1 to ca 15 wt %.

8. A molding composition as defined in claim 1, characterized in that the content of hydrophobic monomeric component is from 1 to 12 wt %.

9. A molding composition as defined in claim 1, characterized in that the content of hydrophobic monomeric component is from 2 to 10 wt % and preferably from 3 to 8 wt %.

10. A molding composition as defined in claim 1, characterized in that said molding composition also comprises at least one particulate hydrophobic and/or oleophobic material.

11. A molding composition as defined in claim 10, characterized in that said particulate hydrophobic and/or oleophobic material is polytetrafluoroethylene, a fluorocarbon elastomer based on poly(vinylidene fluoride-co-hexafluoropropylene)s, polypropylene, a polypropylene copolymer, hydrophobed silicic acid, or a silicone elastomer.

12. A molding composition as defined in claim 10, characterized in that the content of particulate hydrophobic and/or oleophobic material is from ca 0.5 to ca 15 wt %, preferably from 1 to 10 wt %, and more preferably from 2 to 7 wt %.

13. A molding composition as defined in claim 10, characterized in that said hydrophobic and/or oleophobic material has a particle size or particle agglomerate size of <500 μm and preferably, on average, ≦50 μm.

14. A shaped plastics article, produced using a molding composition as defined in claim 1.

15. A shaped plastics article as defined in claim 14, characterized in that at least one face surface layer of said shaped article is composed of the molding composition.

16. A shaped plastics article as defined in claim 15, characterized in that said face surface layer has a thickness of 1 mm or more.

17. A shaped plastics article as defined in claim 14, characterized in that said hydrophobic and/or oleophobic material is substantially homogeneously distributed in the regions formed by said molding composition.

18. A shaped plastics article as defined in claim 14, characterized in that said shaped article is a kitchen sink unit or a kitchen worktop.

19. A method of using organosiloxanes functionalized with at least one unsaturated group as the monomeric component of curable molding compositions for use in the production of shaped articles for sanitary facilities, particularly kitchen sink units and kitchen worktops.

20. A method as defined in claim 19, characterized in that said molding composition is a molding composition as defined in claim 1.

21. A shaped plastics article as defined in claim 15, characterized in that said hydrophobic and/or oleophobic material is substantially homogeneously distributed in the regions formed by said molding composition.

22. A shaped plastics article as defined in claim 15, characterized in that said shaped article is a kitchen sink unit or a kitchen worktop.
